(19) United States
(12) Patent Application Publication
(10) Pub. No.: US 2017/0025685 A1
(43) Pub. Date: Jan. 26, 2017

(54) METHOD FOR REGENERATING ALKALINE SOLUTIONS

(71) Applicant: PHINERGY LTD., LOD (IL)

(72) Inventors: ILYA YAKUPOV, REHOVOT (IL); AVIEL DANINO, BET SHE'AN (IL)

(73) Assignee: PHINERGY LTD., LOD (IL)

(21) Appl. No.: 15/301,024

(22) PCT Filed: Apr. 2, 2015
(86) PCT No.: PCT/IL2015/050364

§ 371 Date: Sep. 30, 2016

Related U.S. Application Data
(60) Provisional application No. 61/974,454, filed on Apr. 3, 2014.

(51) Int. Cl. H01M 6/50; C01D 1/32; H01M 12/06; C01D 1/34

(52) U.S. Cl. CPC H01M 6/5077; C01D 1/34; C01D 1/32; H01M 12/06

(57) ABSTRACT

This invention relates to the regeneration of spent alkaline solutions, for example, alkaline electrolyte solutions used in metal/air batteries, specifically in aluminum/air batteries. The invention provides methods and systems to regenerate alkaline electrolyte solutions by adding water and optionally other solvents to spent electrolyte solutions, thus precipitating metal hydroxides from the spent electrolyte solution.

### FIELD OF THE INVENTION

The invention relates to the regeneration of spent alkaline solutions, for example, alkaline electrolyte solutions used in metal/air batteries, specifically in aluminum/air batteries.

### BACKGROUND OF THE INVENTION

In its most general form, the operation of a metal/air electrochemical cell is based on the reduction of oxygen, which takes place at the cathode, and the oxidation of metallic anode. Ion conductive electrolyte fills the space between the electrodes (cathode and anode) of the cell, closing (together with external load) the electrochemical circuit.

A typical structure of a metal/air cell is schematically shown in FIG. 1, in which the air cathode, the consumable metallic anode and the electrolyte are shown. These components (the cathode, anode and electrolyte) are described in more detail below.

A commonly used air cathode consists of a porous layer of active electrode particles, having catalytic property regarding the oxygen reduction reaction (layer that faces electrolyte), and the gas diffusion layer (the one that face ambient air), which has a property of gas permeability, while is impermeable to electrolyte; e.g., when aqueous electrolyte is applied, such a combination of properties of the air cathode is provided by combination of relatively hydrophilic active (catalytic) layer and hydrophobic gas diffusion layer.

The anode immersed in the electrolyte, is made of metals such as lithium, aluminum, zinc, magnesium, iron and alloys thereof. When aluminum anode is used, then the cell is a primary cell, i.e., recharging of the cell is effected by replacing the spent aluminum anode with a fresh anode. In the case of zinc anode, both primary and secondary cells are known. Aluminum is one of the most energy-dense anodic materials, having theoretical capacity above 8 kWh/kg.

Turning now to the electrolyte, both static and flowing electrolyte concepts are known. Flowing electrolyte better suits high-power applications, because of issues of reaction products removal, and of thermal management. Engineering implementation of flowing electrolyte usually includes the electrolyte tank (external to the battery itself, as shown in FIG. 1). Electrolyte flow may be spontaneous or driven by pump.

For the high-power applications, such as aluminum/air batteries, the aqueous alkaline electrolyte (such as concentrated potassium or sodium hydroxide aqueous solution) is a preferable electrolyte solution from the point of view of electrolyte ionic conductivity and metal-air battery power.

It is noted that the oxidation reaction of an aluminum anode in an alkaline electrolyte (e.g., potassium hydroxide) results in the formation of the aluminate ion [Al(OH)₄]⁻ as shown below:

4Al₍ₛ₎+3O_{2(g)}+6H₂O+4KOH_{(aq)}→4K⁺_{(aq)}+4Al(OH)_{4(aq)}⁻ (I)

During discharge, i.e., energy generation, as the concentration of the aluminate within the recirculating electrolyte increases, the battery voltage decreases, due to the reduction in the ionic conductivity of the electrolyte and lack of free hydroxide ions. Thus, the operability of the electrolyte solution deteriorates gradually with time of operation and once it drops below an acceptable level, the electrolyte is considered a “spent electrolyte”.

In U.S. Pat. No. 4,908,281 it is explained that after the dissolved aluminate exceeds saturation level, the precipitation of solids takes place in the recirculating alkaline electrolyte due to the following reaction:

4K⁺_{(aq)}+4Al(OH)_{4(aq)}⁻→4Al(OH)_{3(solid)}+4KOH_{(aq)} (II)

Reaction (II) is therefore supposed to release potassium hydroxide from the corresponding aluminate and concurrently form a precipitate of aluminum tri-hydroxide (ATH). If the rates of reactions (I) and (II) are balanced, then aluminum-air battery can operate unlimitedly, provided aluminum anode is available, and aluminum tri-hydroxide product is removed from the electrolyte.

However, experimental work carried out in connection with the present invention indicates that this above mentioned “balanced” operation is not always practically achievable because of two major technical obstacles:

Kinetics of reaction (II) is not the preferable one, and can be easily hindered by different factors (such as operation conditions and impurities). Poor kinetics of reaction (II), at “balanced” operation, imposes the limitation on the possible rate of reaction (I), and thus, on the battery power.

Aluminum tri-hydroxide solid particles morphology also is not always the preferable one, and is sensitive to many different factors (such as supersaturation level, precipitation rate, electrolyte media properties, etc.). In many cases the particle size and morphology of ATH precipitate does not allow its robust removal from the electrolyte flow at the required rate.

FIG. 2 is a bar diagram illustrating the composition of a fresh electrolyte consisting of 30% w/w aqueous potassium hydroxide solution (left bar) and a spent electrolyte withdrawn from an aluminum/air battery (right bar). The results indicate that most of the aluminum, dissolved during battery operation appears in the spent electrolyte as dissolved potassium aluminate, with only minor fraction appearing in a form of ATH precipitate. Likewise, the quantity of the solid phase (the aluminum-containing precipitate) which spontaneously precipitates is small.

In many cases such way of aluminum air battery operation (whereas alkali aluminate is the major product of the anode dissolution reaction, and almost no solid product appears in the used electrolyte) is preferable, because of the absence of engineering issues, connected to the solid matter (necessity of filtering, undesired precipitate accumulation in the electrolyte flow path, danger of system clogging, etc. However, at the end of battery operation, the spent electrolyte, which is mostly alkali aluminate solution, should be regenerated for further use.

Consequently, the regeneration of potassium (or sodium) hydroxide from spent electrolyte, such that it may be recycled and reused in the metal/air battery, poses a challenge to the rapidly developing electric vehicle industry where such batteries are employed for powering vehicles. A feasible method for regenerating the alkalinity of spent electrolyte solution would constitute a major advancement in metal/air battery technology.

### SUMMARY OF THE INVENTION

This invention provides methods and systems for regeneration of alkaline solutions containing products of metals dissolution. Specifically, the invention provides method, and a system for regeneration of spent electrolyte of alkali metal-air batteries. The Method allows the separation of dissolved metals in the form of solid metal hydroxide, and regeneration of the alkali solution to the level allowing subsequent use in the metal-air battery. The method is also applicable to the spent electrolyte of hydrogen generators, based on the principle of reaction of metals (such as aluminum and zinc) with aqueous alkaline solution.

Methods of this invention are based on the hydrolysis of alkali solutions containing metal ions by the addition of water, or by the addition of water mixed with an organic co-solvent. As a result of the hydrolysis process, metal ions release the bound alkalinity, and decompose into insoluble hydroxide precipitate, which may be subsequently separated. Regenerated alkali solution, depending on conditions, contains from 40% to 2-3% weight percent of the metal ions, comparing to the spent electrolyte before treatment. In some embodiments, the regenerated alkali solution, depending on conditions, contains from 60% to 2-3% weight percent of the metal ions, comparing to the spent electrolyte before treatment. In some embodiments, the regenerated alkali solution, depending on conditions, contains from 40% to 97-98% of the original alkalinity in the form of free alkali. In some embodiments, from a mass of 100 g of Al in the electrolyte before treatment, only a mass ranging between 50 g and 2-3 g of Al is left in the regenerated electrolyte solution following the hydrolysis treatment.

In one embodiment, water is the only material consumed during the process. Organic co-solvent (if used), is completely regenerated and recycled.

Alkaline solution treated according to methods of this invention, comprise substantially lower content of metal ions, and are enriched by free alkalinity. Such alkaline solutions may be re-used as an electrolyte for the operation of metal-air battery.

In one embodiment, this invention provides a method of treating a spent electrolyte solution, the method comprising adding water to the spent electrolyte solution to induce precipitation of metal hydroxide, optionally with the help of seeding, separating the so-formed precipitate from the aqueous mother liquor and recovering an alkali hydroxide solution. In one embodiment, the method further comprising adding one or more water-miscible, low-boiling point organic solvent(s) to the spent electrolyte solution, separating the metal hydroxide precipitate from the aqueous/organic mother liquor, removing the organic solvent from the mother liquor, and recovering an aqueous alkali hydroxide solution. In one embodiment, the organic solvent is selected from the group consisting of alcohols, ketones, dioxolane, dioxanes, tetrahydrofuran. In one embodiment, the alcohol is methanol, ethanol, propanol or a combination thereof.

In one embodiment, this invention provides a method of operating an aluminum/air battery, comprising withdrawing from the battery a spent electrolyte solution of alkali metal aluminate, adding water to the solution to induce precipitation of aluminum hydroxide, separating the so-formed precipitate from the aqueous mother liquor and directing the mother liquor comprising aqueous alkali hydroxide back to an aluminum/air battery.

In one embodiment, the metal hydroxide is aluminum hydroxide or zinc hydroxide. In one embodiment, the spent electrolyte comprises alkali metal aluminates and the alkali is sodium or potassium. In one embodiment, the seeding comprising adding alumina powder, aluminum hydroxide powder, or zinc oxide powder as a seed to the electrolyte. In one embodiment, the water is added in a volume ranging between 30%-80% from 100% volume of the spent electrolyte. In one embodiment, the co-solvent is added in a volume ranging between 10%-300% from 100% volume of the spent electrolyte.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic of aluminum-air battery.

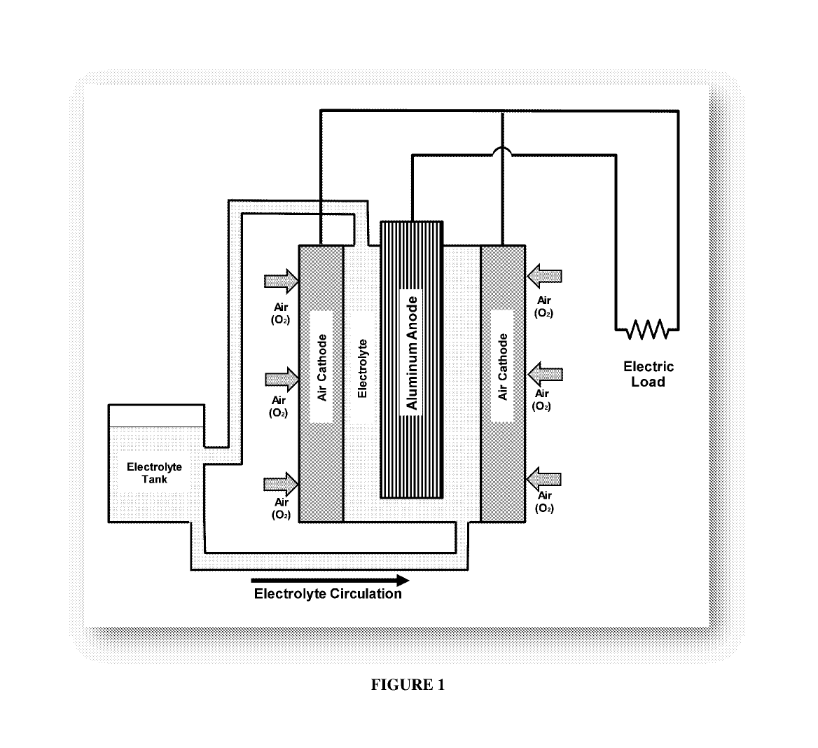

FIG. 2 is a diagram, illustrating the composition of aqueous alkaline electrolyte at the beginning of aluminum-air battery operation (“Fresh Electrolyte”), and close to the end of battery operation (“Spent Electrolyte”).

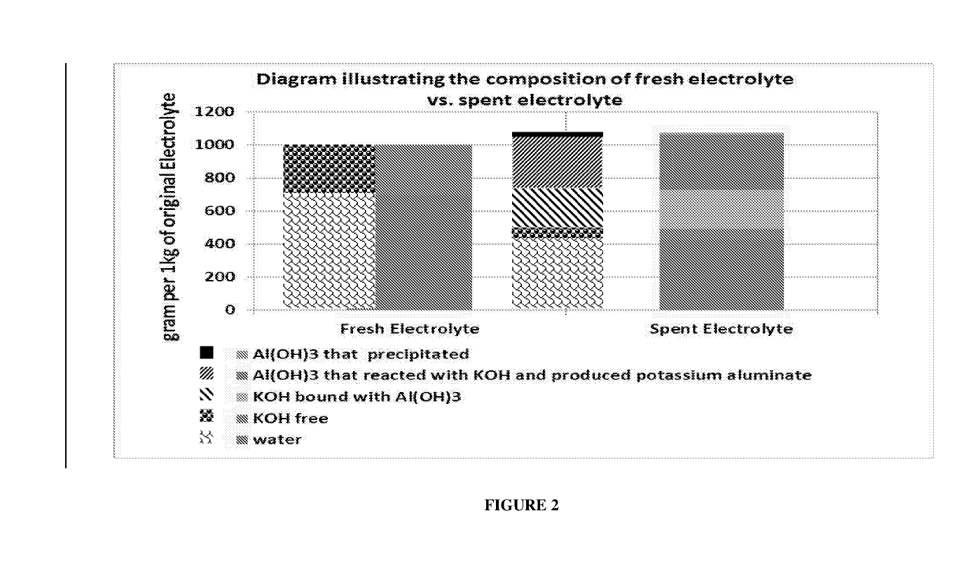

FIG. 3 is an equilibrium diagram for the Na₂O—Al₂O₃—H₂O system at 30° C. (Kirk-Othmer Encyclopedia of Chemical Technology. Copyright John Wiley & Sons, Inc., vol. 2, p. 274) Letters A, B, C, D, E were added for clarification of concentration percentages related to embodiments of this invention. The letter-noted diagram shows the aluminate hydrolysis effect of water addition.

FIG. 4 is a schematic of spent electrolyte regeneration system, including hydrolysis, co-solvent addition option, aluminum tri-hydroxide separation, and the option of co-solvent evaporation and recycling.

FIG. 5 is an illustration of effect of hydrolysis (water addition at a ratio of 40% v/v) on spent electrolyte of aluminum-air battery, according to Example 1—monitoring of aluminate content (as g/L of Al) vs. time. 40% means that 40 ml of water were added to any 100 ml of SE (SE=spent electrolyte).

In some embodiments, the % water addition is ranging between 10% and 300%.

FIG. 6 is an XRD spectrum of solid hydrolysis product (precipitate), obtained in the experiment described in example 1 (the precipitate is identified in the XRD spectrum as gibbsite).

FIG. 7 is particle size distribution analysis of solid hydrolysis product (precipitate), obtained in the experiment described in example 1 (identified as gibbsite).

FIG. 8 is a bar diagram of electrolyte composition (in absolute grams) at different steps of the experiment described in Example 3 (from left to right): fresh electrolyte (KOH 30% w/w aqueous solution); used (spent) electrolyte as withdrawn from the battery after operation; treated by water addition; treated electrolyte separated by vacuum filtering into cake and filtrate; cake after “dewatering” by squeezing, and “recovered liquid” obtained by combining together the liquid squeezed from the cake, and the filtrate (KOH recovery level ˜50%). The recovery level in the recovered liquid shows how much of the total KOH is in the form of free KOH in the regenerated electrolyte. In other words, the recovery level is the percentage of free KOH in total KOH in the recovered electrolyte; e.g. 1000 g of regenerated electrolyte contains 300 g of total KOH, while free KOH content is 150 g, accordingly, the recovery level is 150/300=50%.

FIG. 9 is a bar diagram (in absolute grams) of composition of spent electrolyte composition at different stages of methanol-assisted hydrolysis, as described in example 4 (from left to right): spent electrolyte after the operation in the battery (original fresh electrolyte was 30% KOH solution); reaction mixture composition after hydrolysis by water/methanol (methanol component is not shown); composition of the cake of vacuum filtration; and recovered liquid composition after methanol evaporation. KOH recovery is 94%.

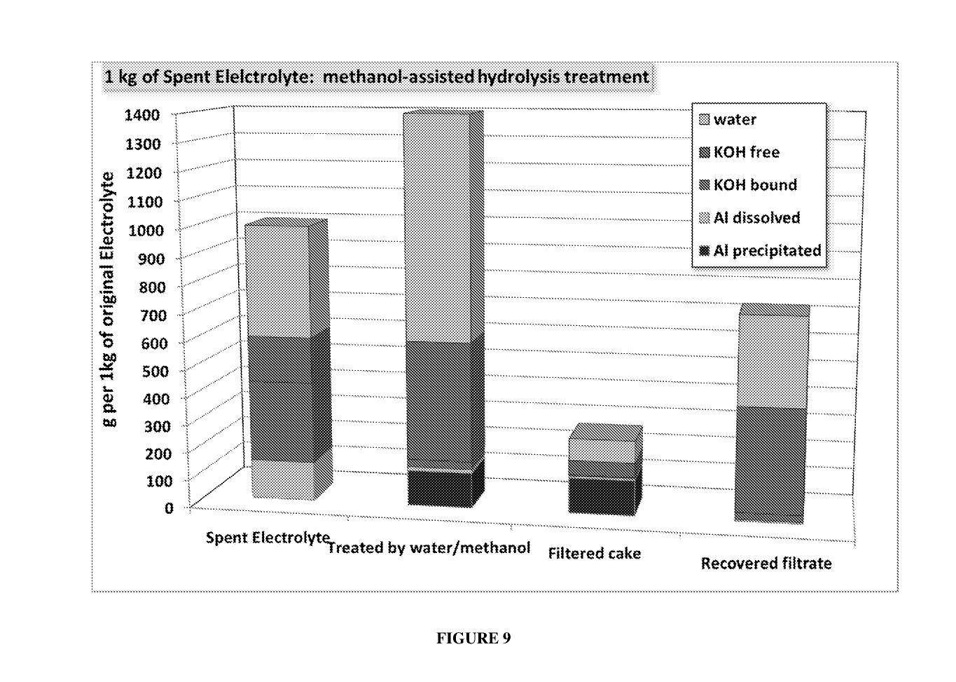

FIG. 10 shows the dependence of the removal of aluminum from spent electrolyte solution (% of Al removed) on the added water-to-spent electrolyte ratio (water % v/v added) as a result of the water hydrolysis process. Removal of aluminum is presented as the ratio of the amount of aluminum removed as a result of the hydrolysis treatment, to the initial amount of aluminum in the spent electrolyte before treatment (spent electrolyte contained 155 g/L of dissolved aluminum).

FIG. 11 shows the recovery of KOH (percentage of free KOH in total KOH) as a function of a ratio of methanol addition (given as percent of methanol volume, whereas volume of spent electrolyte is 100%). Figures were obtained in a series of experiments according to the procedure similar to the one described below in example 4 (hydrolysis by water, followed by methanol addition). Seed was used to assist precipitation. “Commercial” seed is J.M.Huber Hydral 710m aluminum tri-hydroxide, “cake seed” is ATH powder obtained in a previous similar experiment.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Metal-air battery anode (aluminum or aluminum-based alloys, or zinc or zinc alloys), when is operating in alkaline electrolyte, releases products of anodic metal oxidation into the electrolyte. It causes gradual saturation of electrolyte by metal ions (aluminate or zincate ions). This process of metal ion products accumulation in alkaline electrolyte, after a certain degree of saturation would prevent battery from further operation at required rate (by “alkaline electrolyte” here meant aqueous solution of inorganic base, such as, NaOH, KOH, or organic base, such as e.g. choline hydroxide). This “spent” electrolyte, which cannot be used anymore for battery operation, contains the “bound” alkalinity, which may be regenerated.

The disclosed invention provides a method, a process and a system which, being applied to the spent electrolyte, allows to obtain a regenerated alkaline solution, which is suitable for repeated metal-air battery operation. Moreover, the disclosed method allows to separately obtain the product of metal anode oxidation, in a form of a pure metal hydroxide, which is a valuable by-product.

The proposed process is based on shifting of equilibrium reactions (III) and (IV) to the right, as follows:

M⁺_{(aq)}+Al(OH)_{4(aq)}⁻→Al(OH)_{3(solid)}+MOH_{(aq)} (III)

2M⁺_{(aq)}+Zn(OH)_{4(aq)}²⁻→Zn(OH)_{2(solid)}+2MOH_{(aq)} (IV)
(where M is alkali cation, e.g K⁺ or Na⁺)

In the proposed method, such equilibrium shift is implemented by water addition (hydrolysis). It has now been found that addition of water to the spent electrolyte, for example, in an amount of not less than 10% v/v, and preferably not less than 20% v/v, e.g., from 30 to 70% v/v, results in the precipitation of metal hydroxide and release of free alkali. In some embodiments water is added at a ratio of from 10% to 300% of the total volume of the electrolyte. In some embodiments water is added in an amount of between 30%-80% of the total volume of the electrolyte. Volume percent is the percent of water added to 100% volume of spent electrolyte (e.g. 40% water means 40 ml added to each 100 ml of electrolyte).

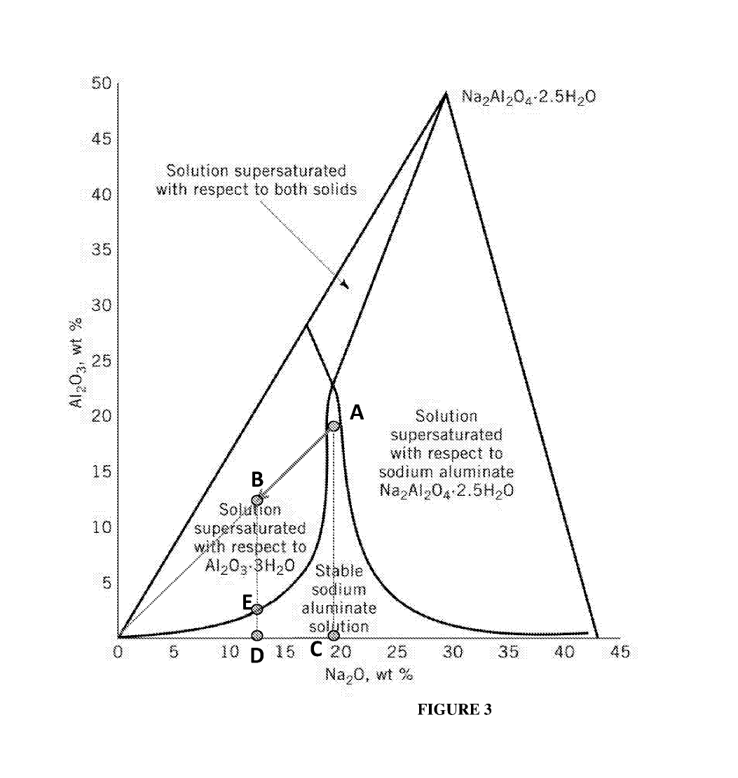

The hydrolysis effect of water dilution may be explained (on the example of sodium aluminate) by a specific behavior of aluminate-hydroxide equilibrium (FIG. 3). On the equilibrium diagram point A corresponds to the solution nearly saturated by aluminate (“spent electrolyte”), and point B corresponds to spent electrolyte after addition of a certain amount of water. It is seen that while point A lays in the area of a stable aluminate solution of high concentration, point B (after dilution) shifts the system to the area supersaturated regarding aluminate, where stable aluminate concentration is times lower (E-D section, comparing to A-C). Excessive aluminate, corresponding to the section B-E will precipitate as aluminum tri-hydroxide, as a result of such water addition.

In one embodiment, seed is added to the reaction mixture of the hydrolysis process, in order to improve the kinetics of precipitation, and to control the particle size of the newly formed metal hydroxide particles, which, in turn, enables better solid/liquid separation. Examples of seed material (not limited to) are alumina powder, aluminum hydroxide powder, or zinc oxide powder, added in an amount (calculated to the total surface area) of e.g. 1-5, or 5-20 m² per liter of the reaction mixture of hydrolysis.

Metal hydroxide precipitate can be separated from the hydrolysis reaction mixture by any appropriate method of solid/liquid separation (gravitational sedimentation, vacuum or press-filtering, centrifugation). According to this aspect and in one embodiment, process of separation of small metal hydroxide particles usually results in the solids “cake”, containing non-negligible amount of liquid. Such a cake usually required additional treatment, such as pressing/squeezing, water washing, and/or air blowing in order to extract as much valuable entrapped alkali as possible.

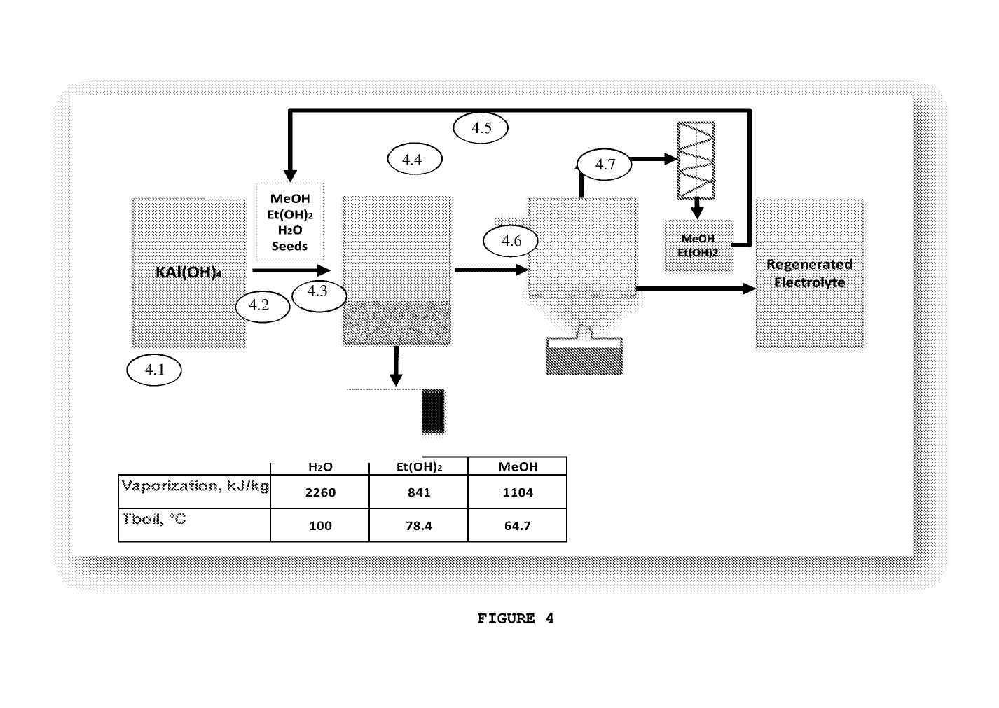

In one embodiment of this invention, it was also established that water hydrolysis in combination with addition of certain organic co-solvent (examples are lower alcohols, such as methanol and ethanol, and/or ketones) may enhance the hydrolysis effect, causing more aluminate to decompose into aluminum tri-hydroxide precipitate. Co-solvent application allows the improvement of the degree of removal of metal ions from the spent electrolyte, and increases the free alkalinity content in the regenerated electrolyte. The boiling point of co-solvent in the method proposed in this invention should be lower than that of water, allowing easy and convenient removal of co-solvent from regenerated electrolyte by distillation, and recycling of the co-solvent in the process, as illustrated in FIG. 4.

In one embodiment, the amount of co-solvent addition ranges from 10% to 300% (volume percent) added to the 100% volume of spent electrolyte.

In some embodiments, co-solvents added to the spent electrolyte include but are not limited to alcohols (such as methanol, ethanol, propanol or others), ketones, dioxolane and dioxanes, tetrahydrofuran, and or other water-miscible, or partly water-miscible organic solvents.

Although co-solvent application imposes an additional step in the process sequence of electrolyte regeneration by hydrolysis, it allows the improvement of the depth of metal ions removal (and corresponding bound alkali release) up to 90%, or more, comparing to 50-60% by water hydrolysis only. (see example 3 with 94% recovery).

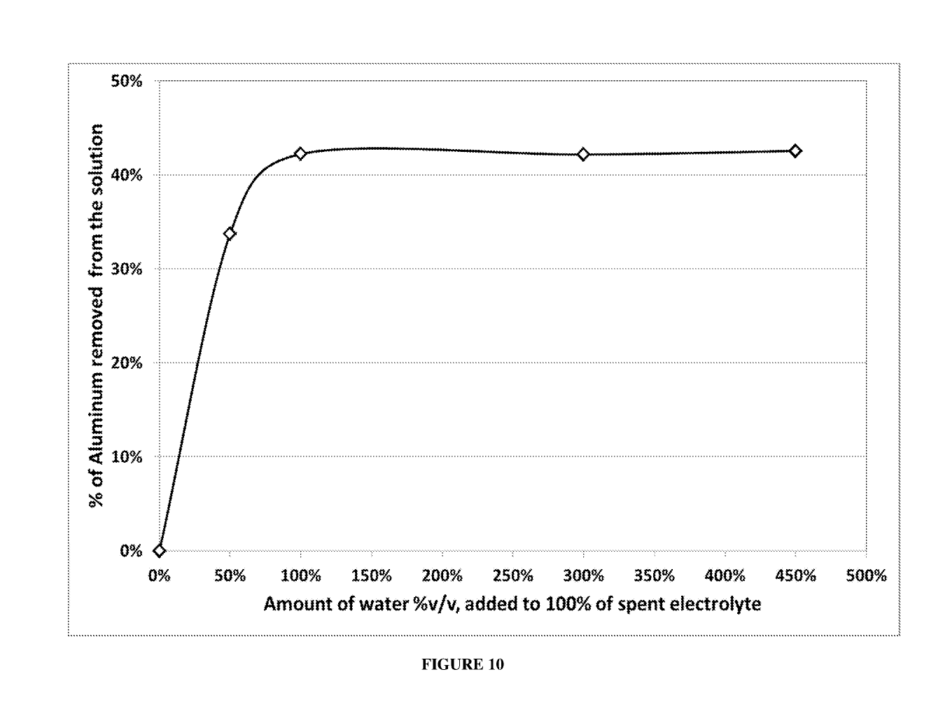

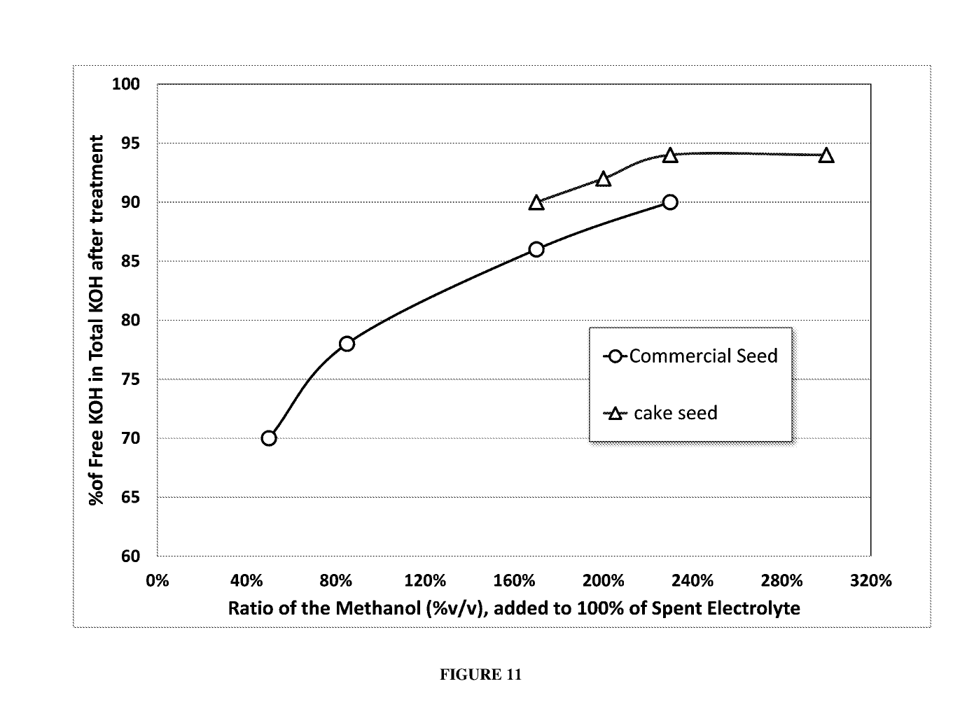

As discussed above and in some embodiments, 90% refers to the percentage of free KOH in total KOH content of the regenerated electrolyte. See also FIGS. 10 and 11 for % KOH recovery vs. water or methanol addition ratio.

In some embodiments, the percent recovery of the KOH in the electrolyte is up to 98%. In some embodiments, the percent recovery of the KOH in the electrolyte is 98%. In some embodiments, the percent recovery of the KOH in the electrolyte ranges between 10% and 98%.

An example of spent electrolyte regeneration process sequence according to an embodiment of this invention is schematically shown in FIG. 4. Spent electrolyte from an aluminum-air battery (which essentially comprises an alkali aluminate solution) is withdrawn from the battery into vessel 4.1, which is essentially a stirred reactor. Water and/or co-solvent (preferably methanol), and (optionally) seed particles are added into the same vessel (stage referred as 4.2), and the mixture is stirred enough time for precipitation to occur. The resulting slurry is separated by separator (filter) 4.3 into aluminum tri-hydroxide cake, and the filtrate liquid. Cake may preferably undergo “de-liquoring” procedure (pressing, water washing, air blowing), which is not shown on the scheme, and the liquid released from the cake is combined with filtrate in the evaporator 4.4.

Evaporator 4.4 may be separate vessel, or reactor 4.1 may serve as the evaporator, if equipped by proper heating and temperature regulation means. Filtrate liquid boils in the evaporator, and methanol vapors leaving the evaporator pass through condenser 4.5, and liquid methanol collected in accumulator 4.6. Regenerated methanol in accumulator 4.6 is then redirected to the reactor for treatment of the next batch of spent electrolyte. Liquid in evaporator, after accomplishing of the methanol (or other co-solvent) stripping is pumped into the regenerated electrolyte collector 4.7, where it can be stored, and eventually re-used in aluminum air battery operation.

In one embodiment, this invention provides a method of treating a spent electrolyte solution, comprising adding water to the spent electrolyte solution to induce precipitation of metal hydroxide, optionally with the help of seeding, separating the so-formed precipitate from the aqueous mother liquor and recovering an alkali hydroxide solution. In one embodiment, the method further comprising adding one or more water-miscible, low-boiling point organic solvent(s) to the spent electrolyte solution, separating the metal hydroxide precipitate from the aqueous/organic mother liquor, removing the organic solvent from the mother liquor, and recovering an aqueous alkali hydroxide solution. In one embodiment, the organic solvent is selected from the group consisting of alcohols, ketones, dioxolane, dioxanes, tetrahydrofuran. In one embodiment, the alcohol is methanol, ethanol, propanol or a combination thereof.

In one embodiment, this invention provides a method of operating an aluminum/air battery, comprising withdrawing from the battery a spent electrolyte solution of alkali metal aluminate, adding water to the solution to induce precipitation of aluminum hydroxide, separating the so-formed precipitate from the aqueous mother liquor and directing the mother liquor comprising aqueous alkali hydroxide back to an aluminum/air battery.

In one embodiment, the metal hydroxide is aluminum hydroxide or zinc hydroxide. In one embodiment, the spent electrolyte comprises alkali metal aluminates and wherein the alkali is sodium or potassium. In one embodiment, the seeding comprising adding alumina powder, aluminum hydroxide powder, or zinc oxide powder as a seed to the electrolyte. In one embodiment, the water is added in a volume ranging between 30%-80% from 100% volume of the spent electrolyte. In one embodiment, the co-solvent is added in a volume ranging between 10%-300% from 100% volume of the spent electrolyte.

In one embodiment, this invention provides a system for regenerating electrolyte. In one embodiment, systems of this invention allow regeneration of spent electrolyte by adding water and optionally co-solvents to the spent electrolyte. FIG. 4 represents one embodiment of a system of the invention. In one embodiment, systems of this invention comprises a tank for spent electrolyte, an inlet for introducing water and other solvents/liquids/solids into the tank and a separation mean for separating solids from the spent electrolyte. In one embodiment, the system further comprises a tank for storage of the regenerated electrolyte following solids separation. In one embodiment, the system further comprises organic solvent separation means. In one embodiment, the organic solvent separation means comprises a heating source, a condenser, a solvent collection vessel or a combination thereof.

In one embodiment, the term “a” or “one” or “an” refers to at least one. In one embodiment the phrase “two or more” may be of any denomination, which will suit a particular purpose. In one embodiment, “about” or “approximately” may comprise a deviance from the indicated term of ±1%, or in some embodiments, −1%, or in some embodiments, ±2.5%, or in some embodiments, ±5%, or in some embodiments, ±7.5%, or in some embodiments, ±10%, or in some embodiments, ±15%, or in some embodiments, ±20%, or in some embodiments, ±25%.

### EXAMPLES

### Materials

Spent electrolyte samples were obtained from an aluminum-air battery. To this end, a fresh electrolyte solution consisting of aqueous KOH solution (30 wt %) was allowed to circulate through an aluminum/air battery consisting of 10 cells at a flow rate of 6 L/min, until the concentration of the K[Al(OH)₄] solution was 140-180 g/liter (calculated as metal aluminum).

### Methods

Aluminum and alkali content of the solutions was measured titrimetrically by the two-complexant procedure originally developed by Watts and Utley [Anal. Chem. 28, 1731 (1956)] and modified by Metrohm AG [“Determination of total caustic, total soda and alumina in Bayer process liquors with 859 Titrotherm”, Application Note 313e, METROHM AG]. Titration analysis was carried out with the help of Metrohm 859 Titrotherm device, operating under Metrohm Tiamo™ software.

Powder x-ray diffraction (XRD) patterns were recorded using BRUKER D8 ADVANCE X-ray Powder Diffraction device (Theta/theta geometry, Cu K-alpha radiation, 40 mA, 40 kV).

Particle size distribution measurement was carried out using Malvern Mastersizer 2000.

### Example 1

### Hydrolysis of Spent Electrolyte—Liquid Phase Composition of Treated and Non-Treated Electrolyte

The following experiments were carried out to demonstrate the effect of water addition to spent electrolyte solution of aluminum-air battery.

In the first experiment (comparative, non-treated), 100 ml of spent electrolyte solution having 147 g/L of aluminate (as Al) was added to a plastic can. The can was closed and allowed to stand at room temperature for a period of approximately 180 hours.

In the second experiment (water treated), 100 ml of the same spent electrolyte solution (147 g/L of dissolve Al) was added to a plastic can, followed by the addition of water (40 ml). The so-formed solution was stirred for two hours. The can was closed and allowed to stand at room temperature for a period of approximately 180 hours.

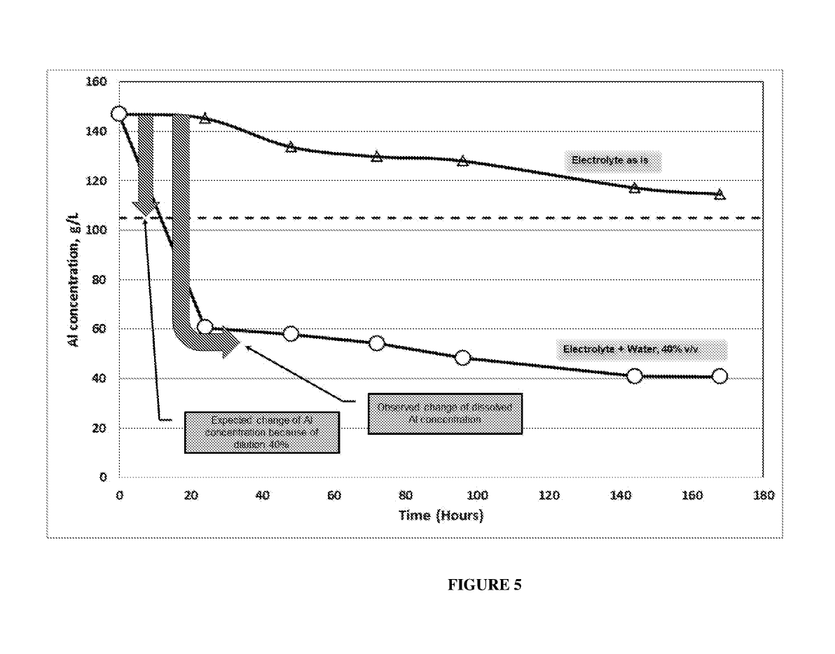

The two K[Al(OH)₄] solutions were sampled periodically during the 180 hours storage period and the concentration of aluminum dissolved in the aqueous phase was measured. The results are shown in FIG. 5, where the aluminum content of each of the solutions is plotted versus time.

The upper curve, marked with triangles, demonstrates the results of the first experiment, devoid of water addition. The upper curve exhibits a slow decrease in the concentration of aluminum dissolved in the aqueous phase, indicating that the K[Al(OH)₄] species in the solution underwent almost no reaction to precipitate aluminum hydroxide and release potassium hydroxide.

The lower curve, indicated by open circles, relates to the second experiment. The lower curve demonstrates that water addition to the K[Al(OH)₄] solution causes a reduction in the concentration of the aluminum dissolved in the aqueous phase. A sharp drop is observed after the first day of experiment, followed by a slower rate of concentration change in the next days. It should be noted that the straight dashed line, which represents the theoretical concentration of aluminum calculated on the basis of the dilution factor due to water addition (147 g/L×100/140=105 g/L) is located above the lower curve. It follows that the dilution of the solution cannot account for the measured reduction of the concentration of aluminum dissolved in the solution. Water addition advances aluminum precipitation in the form of aluminum hydroxide and advances a concurrent release of potassium hydroxide. This is shown by the following chemical reaction:

K⁺_{(aq)}Al(OH)_{4(aq)}⁻→Al(OH)_{3(solid)}+KOH_{(aq)}

### Example 2

### Hydrolysis of Spent Electrolyte Solid Phase Characterization

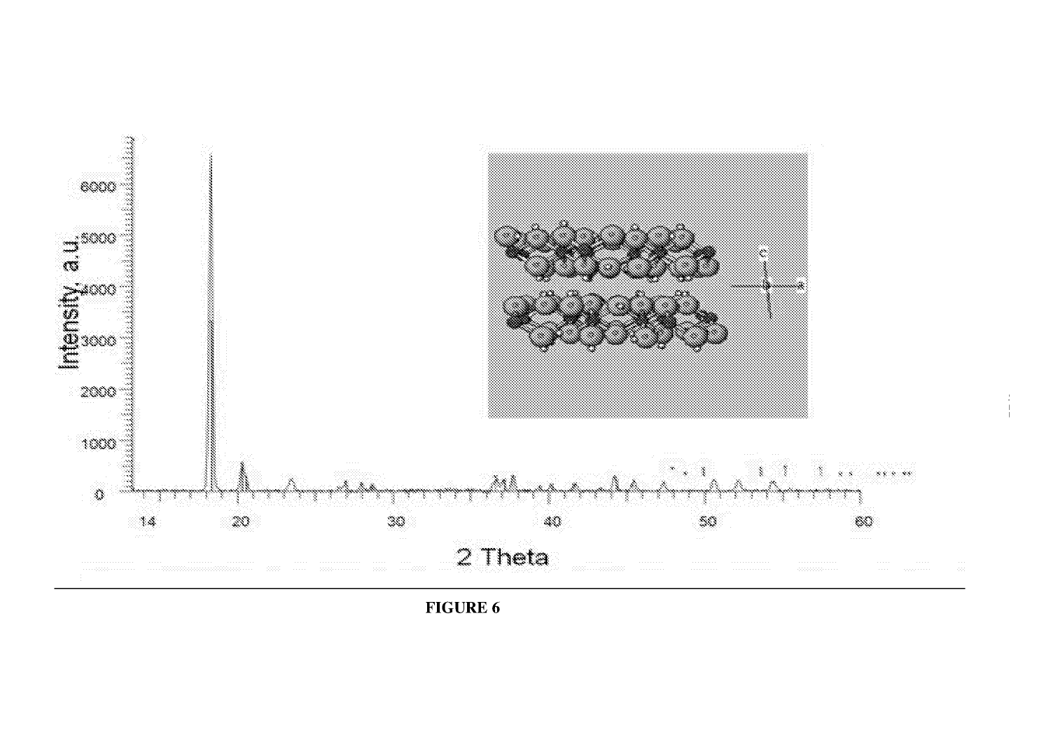

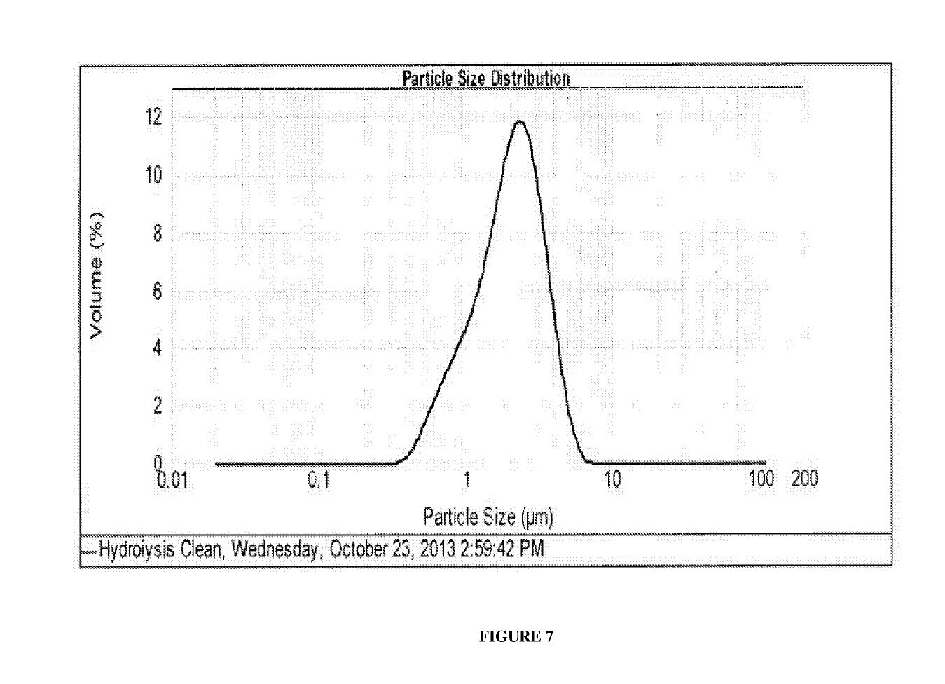

The white precipitate formed in the K[Al(OH)₄] solution, following water addition, as set forth in Example 1, was separated by filtration. XRD analysis indicates that the isolated solid is the gibbsite (sometimes called hydrargillite) form of aluminum hydroxide. FIG. 6 shows the X-ray powder diffraction pattern of the product. A particle size distribution of the so-formed aluminum hydroxide is depicted in FIG. 7, indicating that the particle size is in the range from 1 to 10 μm.

### Example 3

### The Complete Cycle of Spent Electrolyte Regeneration by Hydrolysis (Water Only)

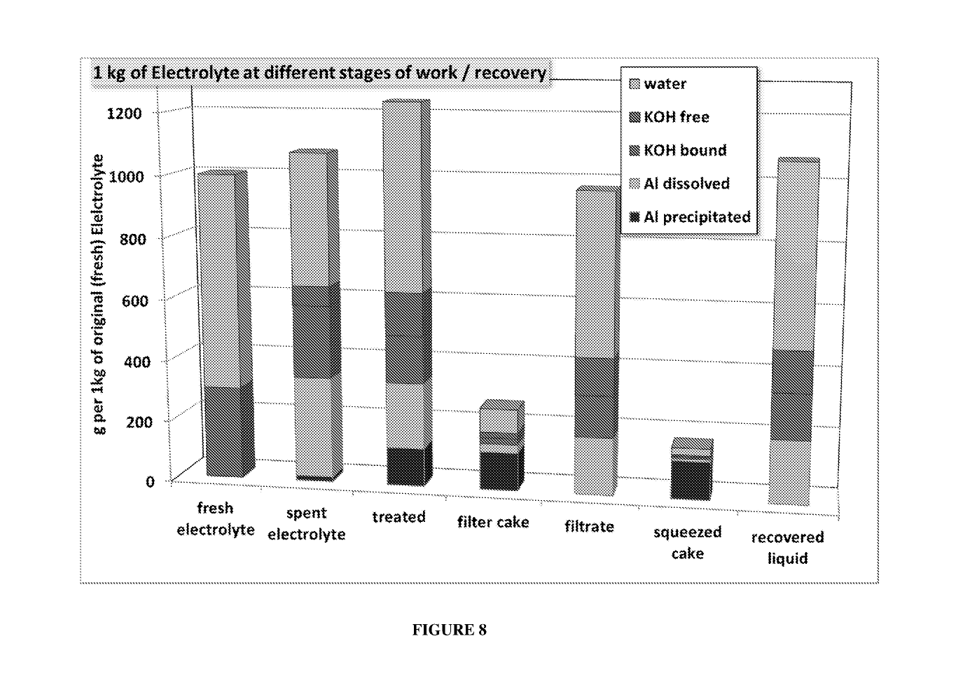

FIG. 8 is a bar diagram showing typical changes occurring in the compositions of aqueous and solid phases used and generated on running the process of the invention on a laboratory scale. Each bar illustrates the distribution of components within the starting material/intermediates/products under consideration. Starting from left to right, the first and second bars represent the composition of a fresh potassium hydroxide solution (30 w/w, 1 kg total weight), and a spent electrolyte solution withdrawn from an aluminum/air battery. The third bar illustrates the composition of the system following water addition. It is noted that volume increase due to water addition is accompanied by a significant increase of the solid phase formed in the system due to K[Al(OH)₄] hydrolysis, which leads to aluminum hydroxide precipitation. The fourth bar illustrates the composition of a wet cake that had been separated from the solution. The fifth bar illustrates the composition of the mother liquor, i.e., the corresponding filtrate. The mother liquor is the liquid phase following separation from the solid precipitate.

In some embodiments, in order to improve the efficacy of the process, the wet cake may undergo a de-liquoring step, e.g., the wet cake may be squeezed by the application of pressure, to remove therefrom a secondary alkaline aqueous fraction, which can be combined with the previously collected mother liquor. The sixth and seventh bars illustrate the compositions of high-solids, squeezed filter cake consisting essentially of aluminum hydroxide, and a combined mother liquor collected in the process, respectively. On an industrial scale, of course, the foregoing solid/liquid separation step may be accomplished in any conventional industrial method, to minimize the amount of mother liquor contained in the filter cake, thereby collecting high-solids cake while maximizing the volume of the potassium hydroxide solution.

Final recovery level of KOH (ratio of free KOH to total KOH) is ˜50%: finally, in this example 1071 g of liquid was recovered. This recovered liquid, or regenerated electrolyte, had total KOH content 283 g, 135 g of each was established as free KOH (percentage of free KOH: 135 g/283 g=47.6%).

### Example 4

### Spent Electrolyte Regeneration by Methanol-Assisted Hydrolysis

Al-air battery was operated with 30% KOH solution until concentration of aluminum in the liquid was 180 g/L (as [Al]). Thus spent electrolyte (1 kg) was removed from the battery system and put to stirred vessel with reflux at 55° C. Warm water (55° C.) was added to the electrolyte in the vessel at volumetric ratio 0.7/1 (water to electrolyte). 10 g of seed (ATH from a previous experiment) was added. In the course of the next 16 hours methanol was added dropwise, up to the final volumetric ratio 2.3/1 (methanol to electrolyte), at continuous stirring. Two hours after water addition, temperature of the vessel was decreased to 40° C. 20 hours after water addition, the treatment was terminated, and the reaction mixture was filtered. Filtrate was stripped of methanol by distillation, and analyzed for KOH and aluminum content (3.4 g/L of [Al] was found in filtrate).

Final recovery rate of KOH was 94%.

Eventually, in this experiment 730 g of liquid were recovered (regenerated electrolyte), which contained 402 g of total KOH, 378 g of which appeared as free KOH (94%).

### Example 5

### Hydrolysis at Different Water Addition Ratio

Al-air battery was operated with 30% KOH solution until concentration of aluminum in the liquid was 155 g/L (as [Al]). Such spent electrolyte was withdrawn from the battery, and divided into several portion of known volume, each one was placed into the stirred plastic beaker. Water (DI) was added to each beaker, in such amounts, that range of values of volumetric ratio of water to spent electrolyte spanned between 50:100 and 450:100 (or from 50% to 450%). All beakers were stirred at room temperature during 12 hours. After that, slurries from each beaker were filtered of freshly precipitated aluminum tri-hydroxide, and [Al] and [KOH] concentrations were established in the filtrate liquid (by titration method, as previously mentioned).

Data, obtained in the experiment is presented in FIG. 10 as a dependence of the efficiency of aluminum removal from spent electrolyte (Y axis) on the volumetric ratio of water to spent electrolyte (X axis).

It is seen that increasing of such ratio above value 80-100% does not contribute to the improvement of the yield of the hydrolysis process according to this embodiment.

### Example 6

### Methanol-Assisted Hydrolysis at Different Methanol Addition Ratio

Experiment with methanol-assisted hydrolysis, similar to that described in Example 4 of this invention, was repeated multiple times with different ratio of volumes of methanol to spent electrolyte (said ration was reported as % v/v of methanol amount to spent electrolyte amount, if spent electrolyte amount is taken as 100%.

KOH recovery (presented as a percentage of free KOH in total KOH), established in regenerated electrolyte samples, is presented in FIG. 11, as a function of methanol addition ratio.

It had been seen that positive effect of methanol addition ratio on the KOH recovery has a kind of saturation behavior, and addition of methanol at a ratio above 280-300% does not contribute further improvement to the KOH recovery according to this embodiment.

Different seeds were applied to the treatment samples in the current Experiment: a commercially available ATH (J.M.Huber Hydral 710), and a home-made ATH powder, prepared from the filtering cake of previous spent electrolyte treatment samples. On the graph shown in FIG. 11 it may be seen that home-made “cake seed” displayed better resulting KOH recovery ratios comparing to “commercial” Hydral 710, apparently because of preferred kinetics of ATH precipitation.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method of treating a spent electrolyte solution of a metal-air battery, the method comprising: adding water and one or more organic solvent(s), or adding one or more organic solvent(s) to the spent electrolyte solution to induce precipitation of metal hydroxide, optionally with the help of seeding, separating the metal hydroxide precipitate from the aqueous-organic mother liquor, removing said organic solvent(s) from the mother liquor, and recovering a solution comprising aqueous alkali hydroxide.

2. (canceled)

3. The method of claim 1, wherein said organic solvent is selected from the group consisting of alcohols, ketones, dioxolane, dioxanes, tetrahydrofuran.

4. The method of claim 3, wherein said alcohol is methanol, ethanol, propanol or a combination thereof.

5. A method of operating an aluminum/air battery, comprising withdrawing from said battery a spent electrolyte solution of alkali metal aluminate, adding water and one or more organic solvent(s), or adding one or more organic solvent(s) to said solution to induce precipitation of aluminum hydroxide, separating the so-formed precipitate from the aqueous-organic mother liquor, removing said organic solvent(s) from the mother liquor and directing the mother liquor comprising aqueous alkali hydroxide back to said aluminum/air battery.

6. The method of claim 1, wherein said metal hydroxide is aluminum hydroxide or zinc hydroxide.

7. The method of claim 1, wherein said spent electrolyte comprises alkali metal aluminates and wherein said alkali-metal is sodium or potassium.

8. The method of claim 1, wherein said seeding comprising adding alumina powder, aluminum hydroxide powder, or zinc oxide powder as a seed to said electrolyte.

9. The method of claim 1, wherein said water is added in a volume ranging between 30%-80% from 100% volume of said spent electrolyte.

10. The method of claim 1, wherein said co-solvent is added in a volume ranging between 10%-300% from 100% volume of said spent electrolyte.

11. The method of claim 1, wherein said addition of water and one or more organic solvent(s) or said addition of one or more organic solvent(s) is conducted sequentially or by addition of a mixture.

12. The method of claim 1, wherein the step of removing said organic solvent from the mother liquor is conducted by distillation.

13. The method of claim 1, wherein following the step of removing said organic solvent from the mother liquor, said organic solvent is recycled.
